(19) United States
(12) Patent Application Publication
(10) Pub. No.: US 2007/0056404 A1
(43) Pub. Date: Mar. 15, 2007

(54) Method and apparatus for and to make hair removal elements

(76) Inventor: Robert M. Pricone, Libertyville, IL (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/227,798

(22) Filed: Sep. 14, 2005

(51) Int. Cl. B23D 63/00

(52) U.S. Cl. 76/25.1

(57) ABSTRACT

A supported cutting device is provided that includes a base and at least one cutting element having a cutting edge. The at least one cutting element extends outwardly from the base and has a geometry that permits the supported cutting device to be separated from a mold along parting lines. The base and the at least one cutting element are integrally formed of a metallic material applied by a deposition process. A method of making a supported cutting device is also provided. The method includes the steps of: 1) providing a template having at least one cutting element with a cutting edge; 2) forming a mold using at least a portion of the template that includes the at least one cutting element; 3) depositing a metallic material onto the mold to form a supported cutting device that includes a base and at least one cutting element; and 4) separating the supported cutting device from the mold.

### TECHNICAL FIELD

The present invention is generally related to devices for shaving hair from skin, and methods for manufacturing such devices, and specifically novel methods for manufacturing cutting elements having conventional razor blade geometries or micro-structured features.

### BACKGROUND OF THE INVENTION

Historically, conventional safety-razors used for the removal of hair from skin employ one or more individual blades ground and honed to provide a sharp edge. Additionally, coatings such as chrome, Teflon® or diamond-like coatings are used to reduce drag and improve comfort. Mass production and handling of these blades employs expensive equipment and process control and is generally limited to incremental improvements of conventional blade technology.

Recent technology has moved towards safety-razors consisting of two, three, or four blades. Since the sharpness of the razor blade edge is the primary factor that allows a razor to cut hair effectively, alternate methods to manufacture such edges using technology that also provides construction innovation, not previously achievable, is of significant value to the hair removal industry. The ability to increase the number of the cutting elements or reduce their size so that more cutting elements can be used in a single device is of value compared to current technology.

Although electrodeposition techniques are capable of making extremely accurate copies of structures, they have heretofore not been considered suitable as a method for manufacturing shaving elements, because multiblade razors and cutting elements for hair typically employ specific cutting angles having undercut geometries which result in mechanical interference, thereby obstructing separation of the electrodeposited material from a tool and resulting in damage to either or both the deposited structure and the tool. What is needed is a method of separating electrodeposited metal copies of shaving elements from the original tool without damage to either the original or the copy.

### SUMMARY OF THE INVENTION

The present invention is based on techniques employed by using electrodepositing technology, previously unrelated to the fabrication of shaving devices and that have significant advantages in simplifying the manufacture of hair removal devices by providing arrays and geometries formed as a unitary embodiment.

The electrodepositing process is extremely accurate and capable of replicating surfaces with features of angstrom or even nano-meter size detail. The electrodepositing replication process may begin with a master part that is fashioned with a precise geometry to provide an original part, which may be known as a master or template to be replicated by the electrodepositing process.

According to an aspect of the present invention, a supported cutting device is provided that includes a base and at least one cutting element having a cutting edge. The at least one cutting element extends outwardly from the base and has a geometry that permits the supported cutting device to be separated from a mold along parting lines. The base and the at least one cutting element are integrally formed of a metallic material applied by a deposition process.

In some embodiments, the supported cutting device includes a backing layer applied to a non-engaging surface of the device.

In some embodiments, the supported cutting device includes one or more of the following elements: a guard, a cap, and lateral side panels.

According to another aspect of the present invention, a method of making a supported cutting device is provided that includes the steps of: 1) providing a template having at least one cutting element; 2) forming a mold using at least a portion of the template that includes the at least one cutting element; 3) depositing a metallic material onto the mold to form a supported cutting device that includes a base and at least one cutting element; and 4) separating the supported cutting device from the mold.

In some embodiments, the method of making a supported cutting device further comprises the step of applying a backing layer to a non-engaging surface of the supported cutting device.

Hair removal elements that provide either conventional size features or micro-structured features that can be microfabricated economically and overcome the mass production difficulties of conventional razor blade technology have advantages over the prior art. The invention disclosed herein permits the electrodeposited production of microstructured features with great precision, and their separation without damage combined with the ability to plate high surface hardness metals with high-speed automated equipment.

An advantage of the present invention is the high degree of dimensional tolerance that is possible with a deposition process. The tolerancing makes it possible to produce desirable cutting elements without the multiple manufacturing steps required in conventional blade manufacturing processes. Specifically, the deposition processes make it possible to create microstructured features with great precision.

These and other objects, features, and advantages of the present invention method and apparatus will become apparent in light of the detailed description of the invention provided below and the accompanying drawings.

### BRIEF DESCRIPTION OF THE DRAWINGS

FIG. 1 is a diagrammatic side view of a template of an array of conventional razor blades secured in a substrate.

FIG. 1A is a perspective view of a blade array template similar to that of FIG. 1, secured in a fixture.

FIG. 1B is an enlarged view of a portion of the blade array template shown in FIG. 1A.

FIG. 2 is a top diagrammatic view of a template such as show in FIG. 1A, positioned in an electrodepositing tank.

FIG. 3 is a diagrammatic side view of the template like in FIG. 1A, after a layer of electrodeposited metal has been applied and showing the undercut interfering regions between the template and the applied electrodeposited material forming a mold.

FIG. 4 is a diagrammatic side view of the template shown in FIG. 3, and wherein the mold and the template are being separated from one another.

FIG. 5 is a diagrammatic side view of the mold formed by electrodepositing.

FIG. 6 is a diagrammatic side view of the mold of FIG. 5, positioned in an electrodepositing tank.

FIG. 7 is a diagrammatic side view of the mold, after an electrodeposited metallic material has been applied to the mold to form a supported cutting device.

FIG. 8 is a diagrammatic side view of the mold and the electrodeposited supported array of cutting elements being separated from one another.

FIG. 9 is a diagrammatic side view of the integrally formed supported cutting device.

FIG. 10 is diagrammatic side view of the mold after being electrodeposited to form a new integrally formed cutting device.

FIG. 11 is a side diagrammatic view of the article shown in FIG. 10 prior to forming it around an arcuately shaped object.

FIG. 12 is a diagrammatic side view of the article in FIG. 11, now bent partially around the arcuately shaped object.

FIG. 13 is a diagrammatic side view of the article shown in FIGS. 10-12 after separation from the mold.

FIG. 14 is a perspective view of the instant invention supported cutting device after removal.

FIG. 15 is a diagrammatic side view of the mold shown in FIG. 5, after being electrodeposited with a thin layer of metal.

FIG. 16 is a diagrammatic side view of the mold shown in FIG. 5, with a thin layer of electrodeposited metal and a backing material.

FIG. 17 is a diagrammatic side view of the electrodeposited cutting device and a backing layer in another form of the instant invention.

FIG. 18 is a perspective view of an application of an embodiment of the present invention.

FIG. 19 is a perspective view of an application of an embodiment of the present invention.

FIG. 20 is a perspective view of an application of an embodiment of the present invention.

FIG. 21 is a perspective view of a razor cartridge embodiment that includes an array of blades as a flexible supported cutting device.

FIG. 22 is a diagrammatic side view of continuous electrodepositing process with supported cutting devices being removed from a continuous mold in accordance with one aspect of the present invention.

### DETAILED DESCRIPTION OF THE INVENTION

Now referring to FIGS. 9 and 14, a supported cutting device 20 is provided that includes a base 22 and at least one cutting element 24 having a cutting edge 26. The base 22 and the at least one cutting element 24 are integrally formed of a deposited metallic material. To facilitate the description of the present invention apparatus and method, the “at least one cutting element 24” will be referred to hereinafter in the plural; i.e., “cutting elements 24”. Use of the plural form “cutting elements” should not be construed as meaning there must be more than one cutting element 24 unless specifically so stated. The base 22 has an engaging surface 28 and a non-engaging surface 30. The cutting elements 24 extend outwardly from the engaging surface 28. The non-engaging surface 30 is the surface of the base 22 opposite the engaging surface 28.

The cutting elements 24 have a forward surface 32, an aft surface 34, and a cutting edge 26 extending along an edge at which the forward and aft surfaces meet. The terms “forward” and “aft”, as used herein, define relative position between features. A feature “forward” of another feature, for example, is positioned so that the surface to be worked (e.g., a skin surface being shaved) encounters the forward feature before it encounters the aft feature, if the supported cutting device 20 is being stroked in its intended cutting direction (e.g., shown as arrow “A” in FIG. 14). The cutting edge 26 may be described in terms of a radius.

The cutting elements 24 extend outwardly from the base 22 with a geometry that allows the supported cutting device 20 to be separated from a mold 36 along parting lines 38 without interference as will be described hereinafter. An example of a geometry that allows the supported cutting device 20 to be separated from the mold 36 without interference has cutting elements 24 extending outwardly from the base 22 at an acute rake angle 40 (e.g., at approximately 20°). In embodiments wherein the forward surface 32 and the aft surface 34 of the cutting elements 24 are parallel one another, the surfaces have the same rake angle formed with base 22. In alternative embodiments, the cutting element surfaces 32,34 may be non-parallel; e.g., skewed toward one another so that the cutting element 24 is substantially triangular in cross-section, with each surface 32,34 having a different rake angle 40,41 formed with base 22 as shown in FIG. 14.

The supported cutting device 20 may comprise a variety of metallic materials, including but not limited to nickel and nickel alloys. In some embodiments, the metallic material of the supported cutting device 20 may further comprise a drag reducing material such as Teflon® or other polymer.

The cutting elements 24 extend out from the base 22 an amount referred to herein as the “height” (as shown in FIG. 9 and identified by the reference numeral 42) of the cutting elements 24. The height 42 of a cutting element 24 is defined as the distance between the cutting edge 26 of the cutting element 24 and the base 22, along a line extending perpendicular with the base 22. In some embodiments, the cutting elements 24 all have the same height 42. In other embodiments, the heights 42 of the cutting elements 24 are not all equal. One example of a blade height that has shown to be useful is 150 microns above the base.

FIG. 9 shows a plurality of cutting elements 24 uniformly spaced apart from one another. In alternative embodiments, the spacing between cutting elements 24 may be varied. The cutting elements 24 may parallel one another, as seen in FIG. 14.

The magnitude of the surface hardness of the present invention cutting elements 24 can be varied to suit the application at hand.

In some embodiments of the present invention, the supported cutting device 20 further includes a backing layer 44 (see FIG. 17) attached to the non-engaging surface 30 of the base 22. An example of an acceptable backing layer 44 is a polymeric material. The rigidity of the backing material can be varied to suit the application at hand. For example, certain types of polymers can be applied to a thin base 22 to create a supported cutting device 20 that has physical characteristics (e.g., flexibility) similar to a fabric. Other types of polymers may be used alternatively that provide the base 22 with a rigid support structure.

Now referring to FIG. 21, in some embodiments of the present invention the supported cutting device 20 includes one or more of the following elements: a guard 46 disposed forward of the cutting elements 24, a cap 48 disposed aft of the cutting elements 24, and lateral side panels 50. These elements 46,48,50 may be attached to the supported cutting device 20 in a variety of ways including, but not limited to, being with the supported cutting device 20, adhered or bonded to the supported cutting device 20, or mechanically attached to the supported cutting device 20. In a preferred embodiment, the supported cutting device 20 and one or more of the elements 46,48,50 may be integrally formed. The combined supported cutting device 20 and one or more elements 46,48,50 may then be attachable to a handle.

FIG. 18 illustrates an application of an embodiment of the present invention wherein a supported cutting device 20 is mounted on a handle 52. The engaging surface 28 of the supported cutting device 20 is diagrammatically shown rotated 180° to illustrate the cutting elements 24 relative to the device.

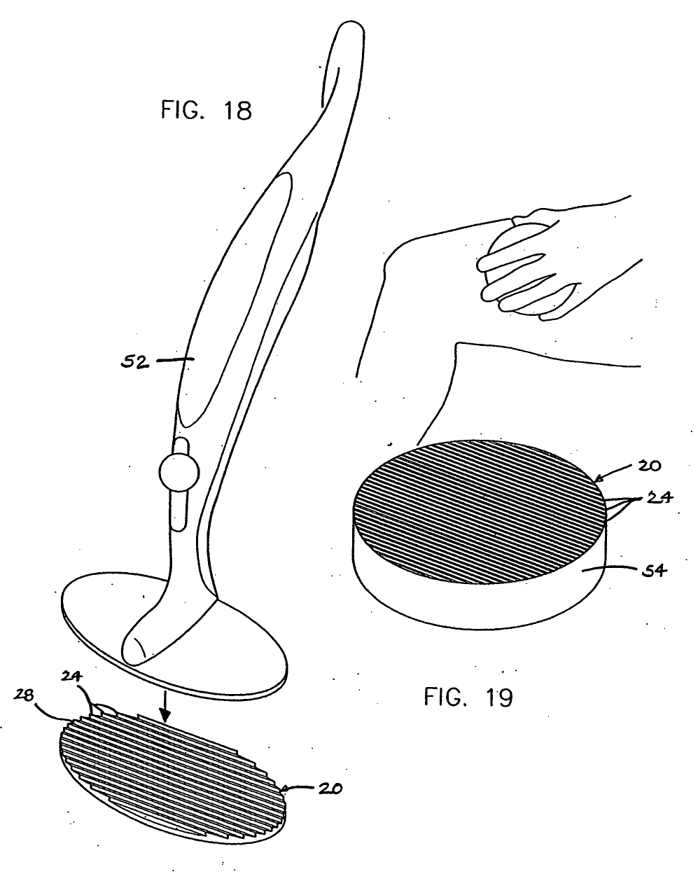

FIG. 19 illustrates another application of an embodiment of the present invention wherein a supported cutting device 20 is mounted on a relatively thick pad 54. FIG. 19 includes a diagrammatic depiction of the device in use on a leg.

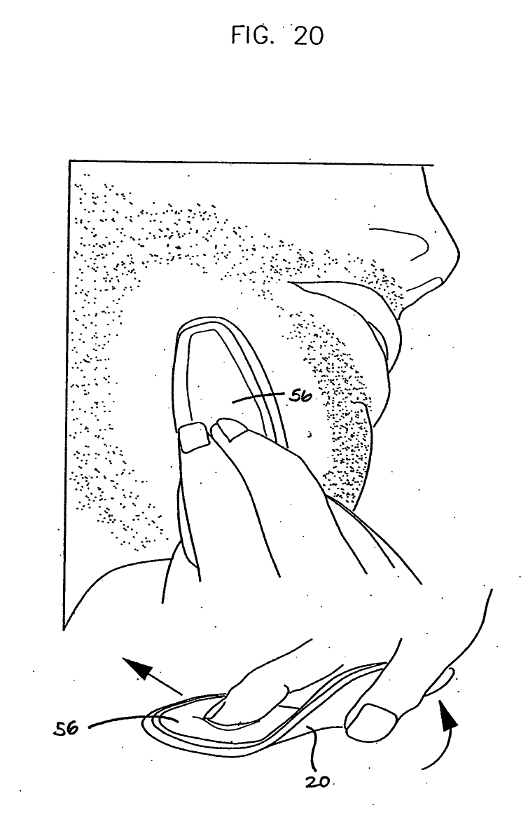

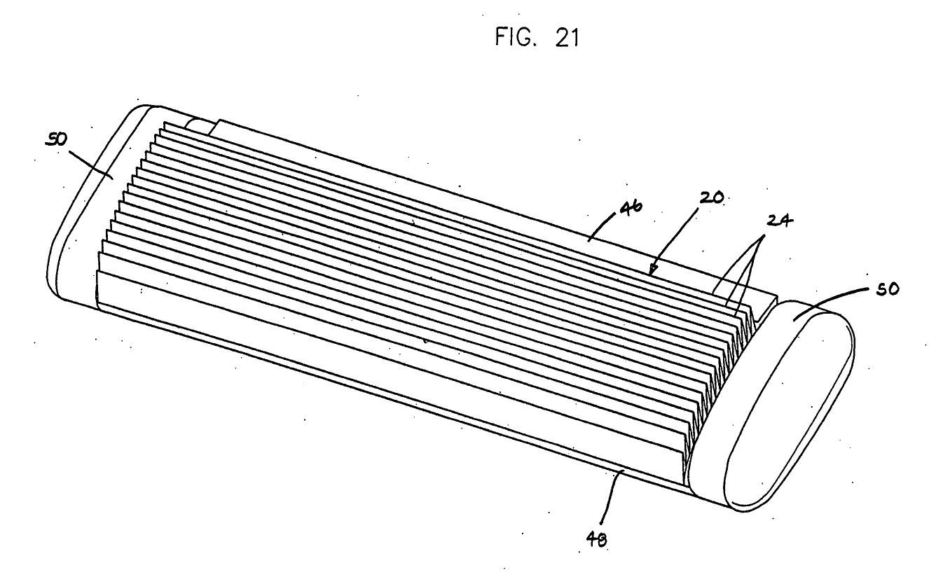

FIG. 20 illustrates yet another application of an embodiment of the present invention wherein a supported cutting device 20 is mounted on a relatively thin pad 56 that provides a fabric-like device.

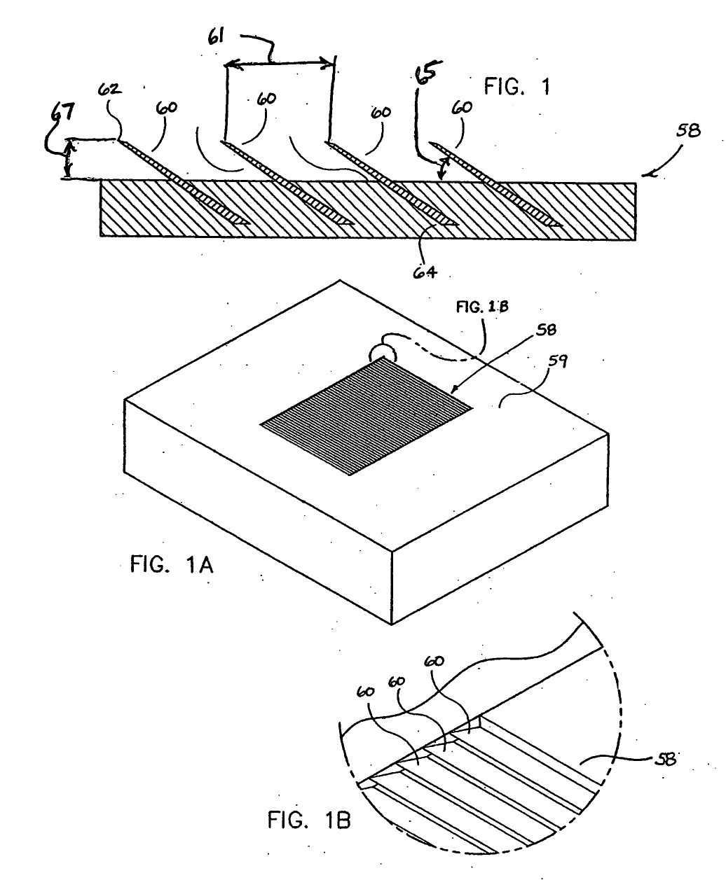

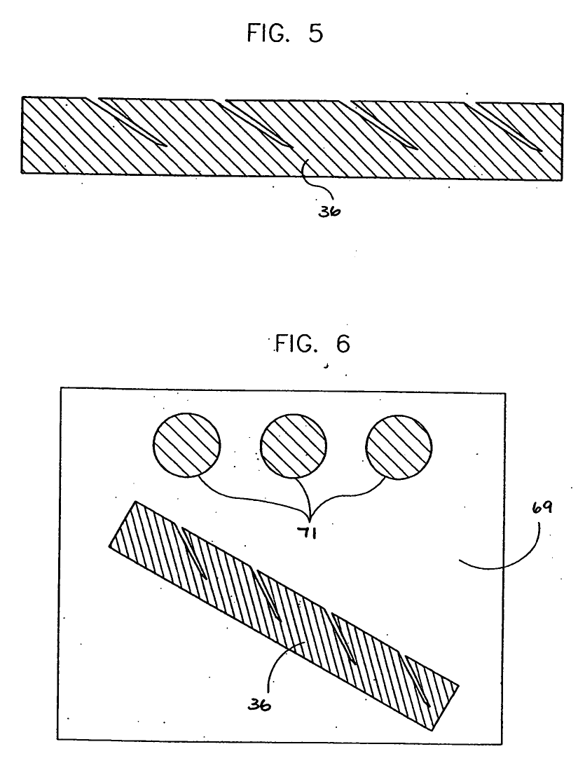

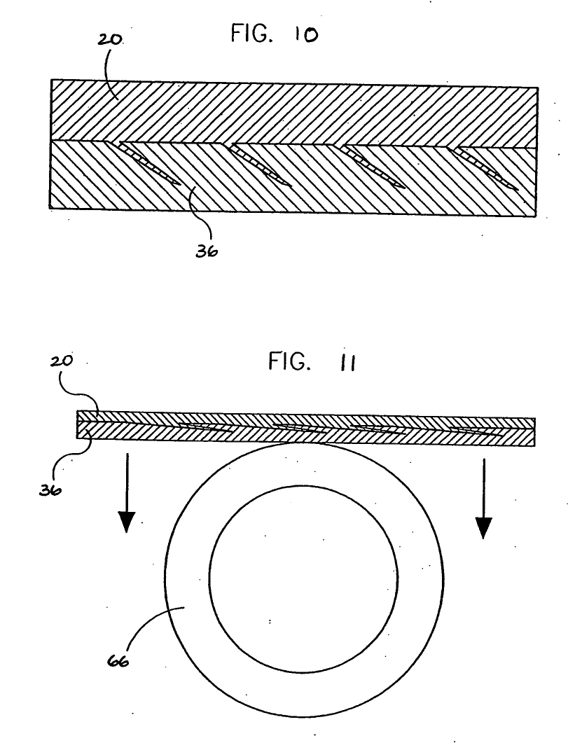

Now referring to FIGS. 1-9, according to another aspect of the present invention, a method of making a supported cutting device 20 is provided. The method includes the steps of: a) providing a template 58 having a substrate 64 and at least one cutting element 60 with a cutting edge 62; b) forming a mold 36 using at least a portion of the template 58 that includes the at least one cutting element 60; c) depositing a metallic material onto the mold 36 to form a supported cutting device 20 that includes a base 22 and at least one cutting element 24; and d) separating the supported cutting device 20 from the mold 36.

The template 58 can assume a variety of forms. As an example, FIG. 1 shows a plurality of cutting elements 60 in the form of single-edge razor blades fixed within the substrate 64. In the illustrated embodiment thirty blades 60 were spaced at a distance 61 of about 0.5 mm apart and raked at an angle 65 of about 20 degrees. The cutting edges 62 project above the surface of the substrate 64 by a distance 67 of about 150 microns. The blade array so described acts as a template 58 to replicate a subsequent mold copy. Blades of this type are typically ground and honed to a nominal edge radius of 300-500 angstroms. Other cutting geometries might be useful and may be made in accordance with the disclosed method. The number of cutting elements 60 and the orientation (e.g., rake angle, height, interblade spacing, etc.) of each cutting element 60 relative to the other cutting elements 60 and the substrate 64 can be varied to suit the application at hand. In addition, the characteristics of the cutting elements 64 (e.g., the shape, cutting edge radius, etc.) can be varied to suit the application at hand. In some applications, the template 58 may have areas that are masked to prevent the deposition of material. The type of masking (e.g., non-conductive resist) may vary depending on the type of metallic material to be applied. FIG. 1A shows the template 58 secured within a fixture 59. FIG. 1B is an enlarged partial view of the template 58 shown in FIG. 1A.

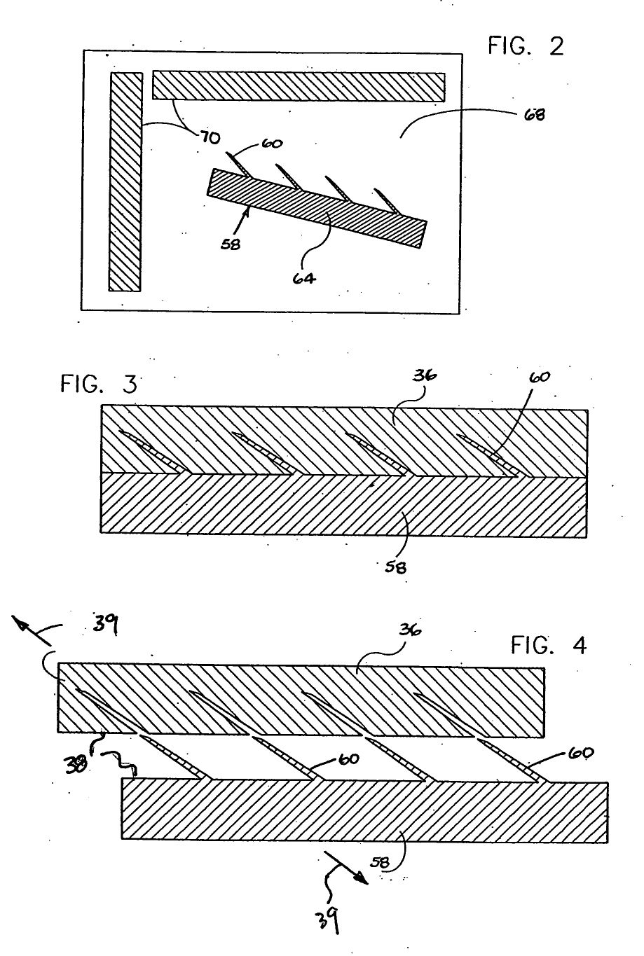

Now referring to FIGS. 2-4, the mold 36 is formed in a process wherein a metallic material is deposited onto the template 58. In one embodiment, the metallic material is electrodeposited onto the template 58 to form the mold 36. In another embodiment, the mold 36 is created when the metallic material is deposited onto the template 58 using an electroless chemical reduction plating process. Once the mold 36 is created it is removed from the template 58. The geometry of the cutting elements 24 permits the mold 36 and template 58 to be parted by pulling each in opposite directions shown by arrows 39 to effect separation along parting lines 38. Aids can be used to facilitate the parting of the mold 36 and template 58; e.g., tape adhered to the mold 36 and/or template 58, or a mechanical clamping structure engaged with mold 36 and/or template 58 can be used to facilitate the parting. The template 58 can be used thereafter as a master to create additional molds 36.

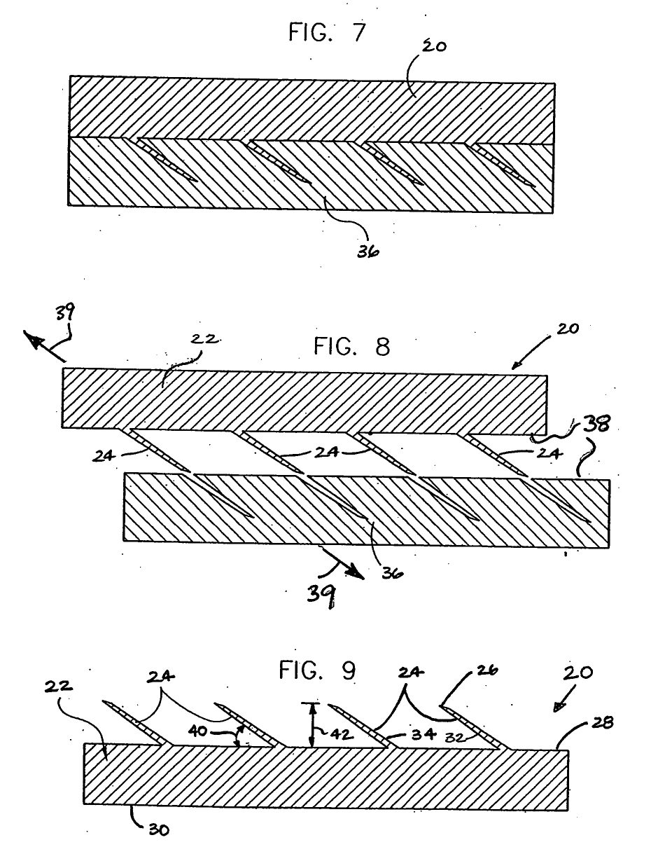

Now referring to FIGS. 5-13, a metallic material is subsequently deposited onto the mold 36 to form a supported cutting device 20 that includes a base 22 and at least one cutting element 24. In one embodiment, the metallic material is deposited using an electrodepositing process. In another embodiment, the metallic material is deposited using an electroless chemical reduction plating process. Other deposition processes may be used alternatively.

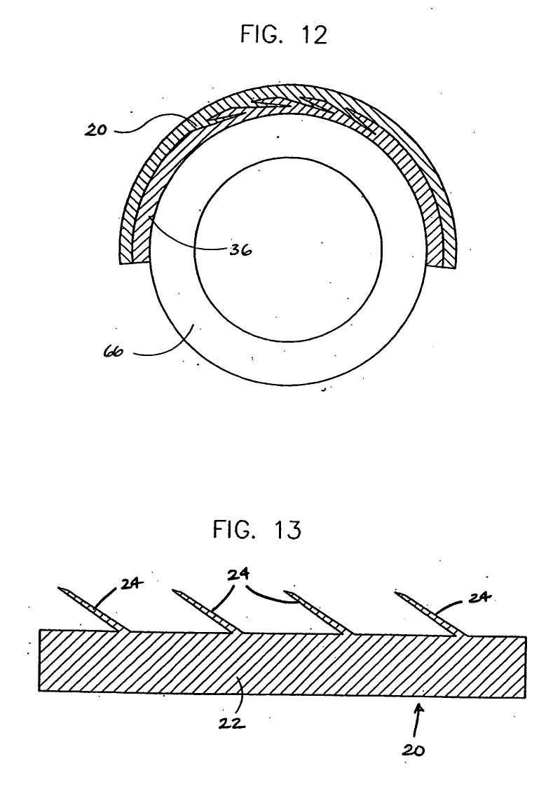

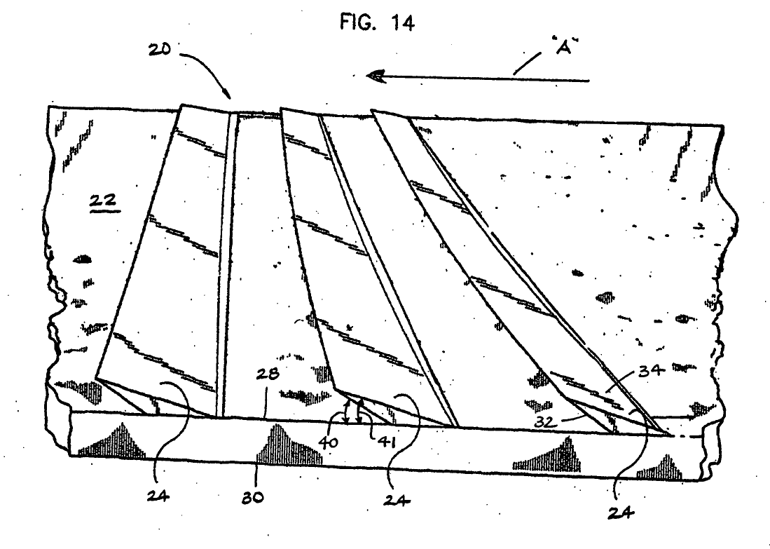

After the supported cutting device 20 has been created, the mold 36 and the supported cutting device 20 are separated from one another. In some instances, the mold 36 and the supported cutting device 20 are parted by pulling each in opposite directions 39 to effect separation along parting lines 38. Here again, aids can be used to facilitate the parting of the mold 36 and supported cutting device 20. For example, the separation of the mold 36 and the supported cutting device 20 can be facilitated by bending the combined mold 36 and supported cutting device 20 around an arcuate body 66, such as a cylinder having a 3 cm radius (as is shown in FIGS. 11 and 12). The bending affects the forces holding the mold 36 and the supported cutting device 20 together (e.g., adhesion forces, material, etc.), and thereby facilitates the separation of the two.

Now referring to FIGS. 16 and 17, in some embodiments a backing layer 44 is applied to the non-engaging surface 30 of the supported cutting device 20. In those embodiments wherein the backing layer comprises a polymeric material, the backing layer 44 may be applied by a variety of known polymer application methods; e.g., applied as a powder coating that is subsequently cured. An example of this embodiment consists of a plating thickness of 20 to 50 microns allowing the outermost part of the product to be plated with hard metal and the polymer backing in the range of an additional 100 to 300 microns thick depending on the product requirements.

The following examples illustrate the method of producing the present invention supported cutting device 20 and the device itself. These are examples, however, and the present invention should not be interpreted as being limited to these examples.

### EXAMPLE I

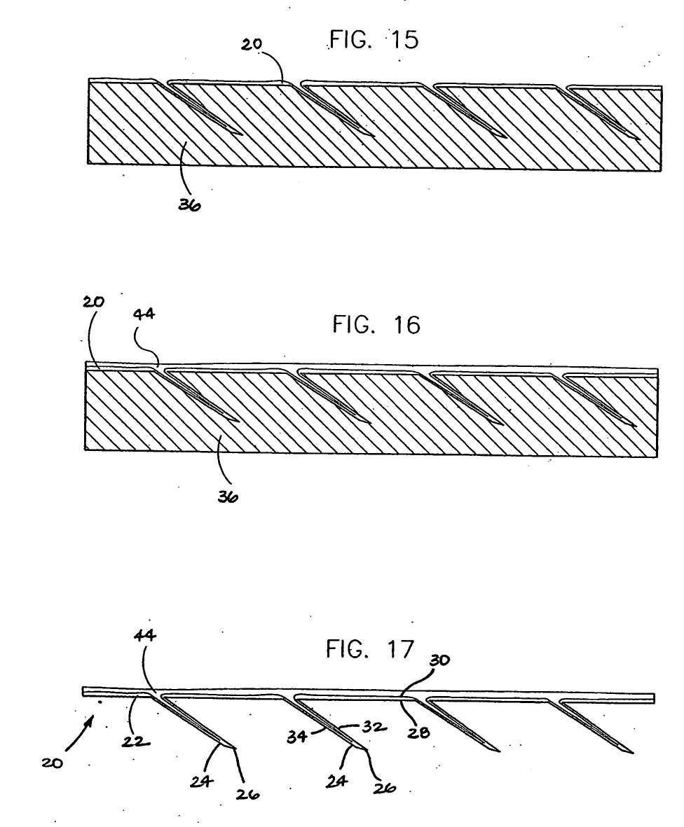

Now referring to FIGS. 1-17, a template 58 is provided within a nickel sulfamate electrodepositing bath 68 (FIG. 2) under the following conditions:

| Nickel (as metal) | 90 | grams per liter |
|---|---|---|
| Specific gravity (Baume) | 30.0° | |
| Boric Acid | 35 | grams per liter |
| pH | 4.0 | |
| Temperature | 44° C. | |
| Anodes | Sulfur bearing electrolytic nickel | |
| Current density - cathode | 10 | amps per sq. ft. |
| Sodium lauryl sulphate | 0.25 | grams per liter |
| 1,3,6 naphthalene trisulfonic acid | 1.0 | grams per liter |

The template of cutting elements shown in FIG. 1 was prepared for electrodepositing using a 2% solution of potassium dichromate for 2 minutes and then rinsed with deionized water as a passivation layer to allow release of the plated copy. The current density of 10 amps per square foot is chosen to help prevent disproportionate deposition at the cutting edges 26 of the cutting elements 24. The anodes 70 are positioned to facilitate uniform deposition of the metallic material on each side of the cutting elements 60 within the template 58. After depositing a metallic material layer of about three hundred (300) microns, the electrodepositing process is halted. The mold 36 created by the metallic material applied to the template 58 is subsequently separated from the template 58 by, for example, pulling the template 58 and the mold 36 opposite one another along parting lines 38.

The mold 36 is then placed in a nickel sulfamate cobalt bath within an electrodepositing tank 69 (FIG. 6) with anodes 71 under the following conditions:

| Nickel (as metal) | 90 | grams per liter |
|---|---|---|
| Cobalt sulfamate | 3 | grams per liter |
| Specific gravity (Baume) | 32.0° | |
| Boric Acid | 35 | grams per liter |
| pH | 4.0 | |
| Temperature | 50° C. | |
| Anodes | Sulfur bearing electrolytic nickel | |
| | and cobalt | |
| Current density - cathode | 10 | amps per sq. ft. |
| Sodium lauryl sulphate | 0.25 | grams per liter |
| 1,3,6 naphthalene trisulfonic acid | 1.0 | grams per liter |

The process continues until a supported cutting device 20 comprising a layer of nickel cobalt alloy having a thickness of about three hundred (300) microns is deposited on the mold 36. The nickel cobalt alloy provides advantageous surface hardness. As an alternative, a nickel, cobalt, phosphorous alloy may be used. The mold 36 and the supported cutting device 20 are subsequently separated from one another by bending the mold 36 and supported cutting device 20 around an arcuate object 66 and/or by pulling the supported cutting device 20 and mold 36 in opposite directions along parting lines 38.

### EXAMPLE II

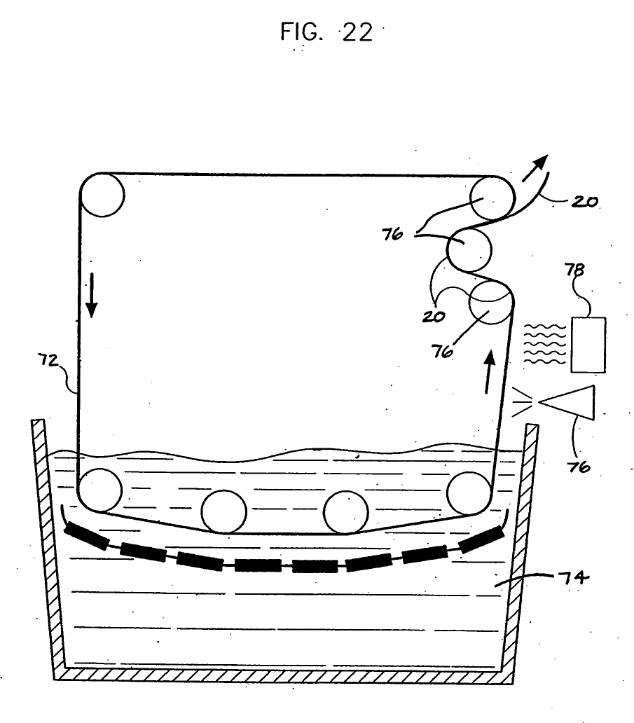

Now referring to FIG. 22, a continuous plating process utilizes a continuous mold in the form of a belt 72 that includes features/patterns on a surface that are shaped and positioned to create the cutting elements 24 and base 22 of one or more supported cutting devices 20. The belt 72 used in this process is similar to those disclosed in U.S. Pat. Nos. 4,601,861 and 4,478,769, both of which patents are hereby incorporated by reference. A part of the belt's travel path extends into and through an electrodepositing bath 74 containing an electrodepositing solution that includes a metallic material, such as hard nickel or nickel alloy. During its dwell time within the bath 74, a layer of metallic material is deposited on the belt 72 thereby forming one or more supported cutting devices 20. The supported cutting devices 20 exit the bath 74 attached to the belt 72. In the diagram shown in FIG. 22, the belt 72 is subsequently drawn around a plurality of rollers 76 typically in the 3 cm radius range to facilitate separation of the supported cutting devices 20 from the belt 72. Once the supported cutting devices 20 are removed from the belt 72, the belt 72 loops back around and into the bath 74 to repeat the process.

In the diagram shown in FIG. 22, the process also includes the step of applying a backing layer 44 to the supported cutting devices 20. The diagram shows a first station 76 wherein a backing layer material (e.g., a polymer) is applied (e.g., by spray) to the non-engaging surface 30 of a supported cutting device 20. In the case of a polymeric backing layer 44, a second station 78 is disposed downstream of the application station 76, wherein the polymeric material is cured.

Although this invention has been shown and described with respect to the detailed embodiments thereof, it will be understood by those skilled in the art that various changes in form and detail thereof may be made without departing from the spirit and scope of the invention.

What is claimed is:

1. A supported cutting element, comprising:
a base; and
at least one cutting element protruding from the base and having a geometry that permits the supported cutting element to be separated from a mold along parting lines, each cutting element having a cutting edge;
wherein the base and the at least one cutting element are integrally formed of an electrodeposited metallic material.

2. A supported cutting element, comprising:
a base; and
at least one cutting element protruding from the base at an acute angle, each cutting element having a cutting edge;
wherein the base and the at least one cutting element are integrally formed of an electrodeposited metallic material.

3. The supported cutting element of claim 2, wherein the base is substantially flat.

4. The supported cutting element of 2, wherein the metallic material is a nickel cobalt alloy.

5. The supported cutting element of claim 2, wherein the acute angle the at least one cutting element extends from the base is approximately 20 degrees.

6. The supported cutting element of claim 2, wherein more than one cutting element extends from the base, each of the cutting elements being positioned generally parallel to one another.

7. The supported cutting element of claim 6, wherein each of the cutting elements extends from the base at approximately the same angle.

8. The supported cutting element of claim 7, wherein the acute angle from which each of the cutting elements extends from the base is approximately 20 degrees.

9. The supported cutting element of claim 2, wherein at least one cutting element has a forward surface and an aft surface.

10. The supported cutting element of claim 9, wherein the forward and aft surfaces extend from the base at different angles such that a cross-section of at least one cutting element is substantially triangular.

11. A method of making a supported cutting element, comprising the steps of:
providing a template having at least one cutting element having a cutting edge, wherein the at least one cutting element has a geometry that allows a mold to be separated from the template along parting lines;
forming the mold using at least a portion of the template;
depositing a metallic material onto the mold to form a supported cutting element having a base and at least one cutting element extending outwardly from the base; and
separating the supported cutting element from the mold along the parting lines.

12. A method of making a supported cutting element, comprising the steps of:
providing a template having at least one cutting element extending outwardly from a substrate at an acute angle;
forming a mold of at least a portion of the template;
electrodepositing a metallic material on the mold to form a supported cutting element, the supporting cutting element comprising a base, at least one cutting element protruding from the base at an acute angle, each cutting element having a cutting edge; and
separating the supported cutting element from the mold.

13. The method of making a supported cutting element of claim 12, wherein the metallic material is a nickel cobalt alloy.

14. The method of making a supported cutting element of claim 12, wherein the angle the at least one cutting element extends from the base is approximately 20 degrees.

15. The method of making a supported cutting element of claim 12 in which more than one cutting element extends from the base, each of the cutting elements being positioned generally parallel to one another.

16. The method of making a supported cutting element of claim 15, wherein each of the cutting elements extends from the base at approximately the same angle.

17. The method of making a supported cutting element of claim 16, wherein the angle from which each of the cutting elements extends from the base is approximately 20 degrees.

18. The method of making a supported cutting element of claim 12, wherein at least one cutting element has a forward surface and an aft surface.

19. The method of making a supported cutting element of claim 18, wherein the forward and aft surfaces extend from the base at different angles such that a cross-section of at least one cutting element is substantially triangular.

20. The method of making a supported cutting element of claim 12, wherein the formed supported cutting element is separated from the mold by applying a force to the mold and the formed supported cutting element in generally opposite directions.

21. The method of making a supported cutting element of claim 12, wherein the mold is placed over an arcuate surface when separating the formed supported cutting element from the mold.

22. A method of continuously forming supported cutting elements, comprising the steps of:
providing a mold that includes a continuous belt having a pattern for molding cutting elements thereon;
moving the mold through an electrodepositing tank such that the pattern for molding cutting elements is submerged in the tank;
forming a supported cutting element by electrodepositing a metallic material onto the mold, the supported cutting element having a base, at least one cutting element extending outwardly from the base at an acute angle, each cutting element having a cutting edge;
removing the mold and the formed supported cutting element from the tank; and
separating the supported cutting element from the mold.

23. The method of making a supported cutting element of claim 22, wherein the base is substantially flat.

24. The method of making a supported cutting element of claim 22, wherein the metallic material is a nickel cobalt alloy.

25. The method of making a supported cutting element of claim 22, wherein the angle the at least one cutting element extends from the base is approximately 20 degrees.

26. The method of making a supported cutting element of claim 22 in which more than one cutting element extends from the base, each of the cutting elements being positioned generally parallel to one another.

27. The method of making a supported cutting element of claim 26, wherein each of the cutting elements extends from the base at approximately the same angle.

28. The method of making a supported cutting element of claim 27, wherein the angle from which each of the cutting elements extends from the base is approximately 20 degrees.

29. The method of making a supported cutting element of claim 22, wherein at least one cutting element has a forward surface and an aft surface.

30. The method of making a supported cutting element of claim 29, wherein the forward and aft surfaces extend from the base at different angles such that a cross-section of at least one cutting element is substantially triangular.

31. The method of making a supported cutting element of claim 22, wherein the mold is moved over a curved surface when separating the formed supported cutting elements from the mold.
